(19) United States
(12) Patent Application Publication
(10) Pub. No.: US 2025/0355320 A1
(43) Pub. Date: Nov. 20, 2025

(54) OPTICAL DEVICE AND IMAGING UNIT INCLUDING OPTICAL DEVICE

(71) Applicant: Murata Manufacturing Co., Ltd., Nagaokakyo-shi (JP)

(72) Inventors: Yuuki ISHII, Nagaokakyo-shi (JP); Hitoshi SAKAGUCHI, Nagaokakyo-shi (JP); Yoshito YAMADA, Kyoto (JP); Junichi YOKOYAMA, Kyoto (JP); Shinji FUJITA, Kyoto (JP)

(21) Appl. No.: 19/281,985

(22) Filed: Jul. 28, 2025

Related U.S. Application Data
(63) Continuation of application No. PCT/JP2023/043792, filed on Dec. 7, 2023.

(30) Foreign Application Priority Data
Mar. 27, 2023 (JP) 2023-050172

(51) Int. Cl. G03B 5/00; G02B 7/02

(52) U.S. Cl. CPC G03B 5/00; G02B 7/022; G02B 7/026; G03B 2205/0061

(57) ABSTRACT

An optical device that includes: a light transmission body that transmits light having a predetermined wavelength; a housing that holds the light transmission body; a joining member adhered to part of the light transmission body; a vibrator having a cylindrical body having a first end with a first portion that contacts the joining member, and a second end with a second portion, the vibrator constructed to vibrate the light transmission body through the joining member; and a piezoelectric element connected the second portion at the second end of the vibrator and constructed to vibrate the vibrator.

### CROSS REFERENCE TO RELATED APPLICATIONS

The present application is a continuation of International application No. PCT/JP2023/043792, filed Dec. 7, 2023, which claims priority to Japanese Patent Application No. 2023-050172, filed Mar. 27, 2023, the entire contents of each of which are incorporated herein by reference.

### TECHNICAL FIELD

The present disclosure relates to an optical device and an imaging unit including the optical device.

### BACKGROUND ART

An imaging unit is provided at a front portion or a rear portion of a vehicle, and, by using an image obtained by the imaging unit, a safety device is controlled or driving assistance control is performed. Since such an imaging unit is often provided outside a vehicle, foreign substances, such as raindrops (water drops), dirt, or dust, may adhere to a light transmission body (a protective cover or a lens) that covers an outer portion.

When a foreign substance adheres to the light transmission body, the foreign substance appears in an image obtained by the imaging unit, and a clear image can no longer be obtained. Therefore, in Japanese Unexamined Patent Application Publication No. 2013-080177 (Patent Document 1), for the purpose of removing any foreign substance adhered to a surface of a light transmission body, an imaging unit includes a vibrator that vibrates the light transmission body.
Patent Document 1: Japanese Unexamined Patent Application Publication No. 2013-080177

### SUMMARY OF THE DISCLOSURE

When, in the imaging unit described in Patent Document 1, the light transmission body (lens) is to be fixed to the vibrator (lens holder where a piezoelectric element is provided) by using an adhesive, for the purpose of ensuring vibration performance and strength, it is necessary to apply pressure to and harden the adhesive such that the thickness of an adhesive layer between the light transmission body and the vibrator becomes uniform.

However, in the imaging unit described in Patent Document 1, pressure needs to be applied to the adhesive by applying a force to an end of the vibrator on an opposite side situated far away from a side thereof that contacts the light transmission body, and thus it is difficult to make uniform the pressure that is applied to the adhesive due to the shape of the vibrator. Therefore, in the imaging unit described in Patent Document 1, variations occur in the thickness of an adhesive layer between the light transmission body and the vibrator, and thus the adhesive layer cannot have uniform thickness, as a result of which vibration performance may deteriorate. Further, depending upon the shape of the vibrator, the vibrator itself may be deformed when applying pressure to the adhesive.

Accordingly, it is an object of the present disclosure to provide an optical device having a structure that can provide an adhesive layer having uniform thickness when a light transmission body is fixed to a vibrator by using an adhesive; and to provide an imaging unit including the optical device.

An optical device according to a form of the present disclosure includes: a light transmission body that transmits light having a predetermined wavelength; a housing that holds the light transmission body; a joining member adhered to part of the light transmission body; a vibrator having a cylindrical body having a first end with a first portion that contacts the joining member, and a second end with a second portion, the vibrator constructed to vibrate the light transmission body through the joining member; and a piezoelectric element connected the second portion at the second end of the vibrator and constructed to vibrate the vibrator.

An imaging unit according to a form of the present disclosure includes the optical device above, and an imaging element that is disposed such that the light transmission body defines a viewing direction.

According to the present disclosure, since the optical device includes the joining member that is adhered to part of the light transmission body, and the vibrator is provided with the joining member being interposed between the light transmission body and the vibrator, it is possible to provide an adhesive layer having a uniform thickness between the light transmission body and the joining member, and vibration performance is prevented from deteriorating.

### BRIEF DESCRIPTION OF THE DRAWINGS

FIG. 1 is a schematic view of an imaging unit according to a first embodiment.

FIG. 2 is a half-cross-sectional view of an optical device according to the first embodiment.

FIG. 3 is a schematic view of a joining member according to the first embodiment.

FIGS. 4(a) and 4(b) are schematic views for illustrating the vibration performance of the optical device when a vibrator is adhered in a parallel manner to an outermost layer lens.

FIGS. 5(a) and 5(b) are schematic views for illustrating the vibration performance of the optical device when the vibrator is adhered in a tilted manner to the outermost layer lens.

FIGS. 6(a) and 6(b) are schematic views for illustrating stress that is applied to the vibrator when adhering the outermost layer lens.

FIG. 7 is a graph showing compressive stress that is applied to a joining surface.

FIG. 8 is a half-cross-sectional view of an optical device according to Modification 1.

FIGS. 9(a) to 9(d) are schematic views for illustrating types of joinings between the joining member and the vibrator.

FIGS. 10(a) and 10(b) are schematic views for illustrating other types of joinings between the joining member and the vibrator.

FIG. 11 is a schematic view for illustrating still another type of joining between the joining member and the vibrator.

FIG. 12 is a half-cross-sectional view of an optical device according to Modification 2.

FIG. 13 is a half-cross-sectional view of an optical device according to Modification 3.

FIGS. 14(a) and 14(b) are schematic views of a joining member according to Modification 3.

FIG. 15 is a half-cross-sectional view of an optical device according to a second embodiment.

FIG. 16 is a half-cross-sectional view of a different optical device according to the second embodiment.

FIG. 17 is a half-cross-sectional view of an optical device according to Modification 4.

### DESCRIPTION OF THE PREFERRED EMBODIMENTS

Optical devices and an imaging unit including any one of the optical devices according to embodiments are described in detail below with reference to the drawings. It should be noted that reference signs in the figures denote the same or corresponding portions. The optical devices that are described below are each applied to, for example, an in-vehicle imaging unit, and can each vibrate a light transmission body (for example, an outermost layer lens) for the purpose of removing any foreign substance adhered to a surface of the light transmission body. The optical devices are not limited to being used in an in-vehicle imaging unit. For example, the optical devices can each be also applied to, for example, an imaging unit for a drone or a monitoring camera for security.

### First Embodiment

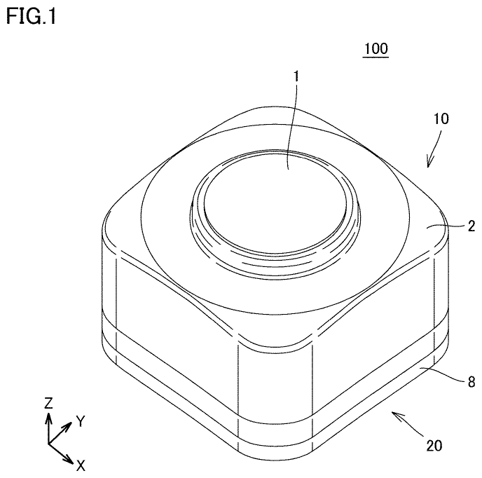

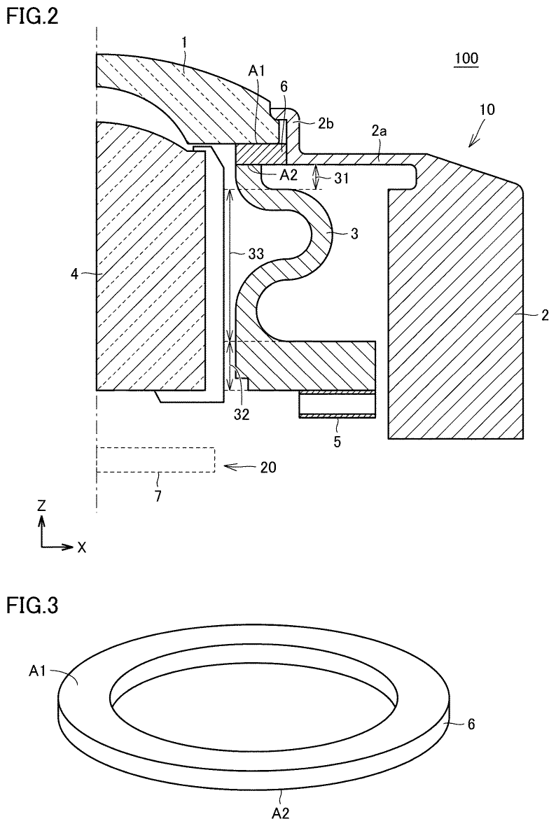

FIG. 1 is a schematic view of an imaging unit 100 according to a first embodiment. FIG. 2 is a half-cross-sectional view of the imaging unit 100 according to the first embodiment. It should be noted that X, Y, and Z directions in the figures denote, respectively, a lateral direction, a depth direction, and a height direction of the imaging unit 100. An alternate long and short dash line in FIG. 2 corresponds to a portion that extends through a central axis of an optical device 10. The imaging unit 100 includes the optical device 10 and an imaging device 20. The optical device 10 includes an outermost layer lens 1, a housing 2, a vibrator 3, an inner layer lens 4, a piezoelectric element 5, and a joining member 6. The imaging device 20 includes an imaging element 7 and a case 8.

It should be noted that the imaging unit 100 is formed by combining the imaging device 20 including the imaging element 7 to the optical device 10 after performing aligning adjustment on the outermost layer lens 1 and the inner layer lens 4. Although, in the present embodiment, the optical device 10 is described as including the inner layer lens 4, the imaging device 20 may include the inner layer lens 4. The imaging unit 100 is to include at least the optical device 10 and the imaging element 7 that is disposed such that the outermost layer lens 1 and the inner layer lens 4 define a viewing direction.

The imaging element 7 is, for example, an image sensor, such as a CCD (Charge Coupled Device) or a CMOS (Complementary Metal-Oxide-Semiconductor) sensor, and is mounted on a circuit board (not shown). The circuit board not only is one where a semiconductor element of, for example, a general-purpose IC (Integrated Circuit) or ASIC (Application Specific Integrated Circuit) for controlling the imaging element 7 is mounted, but may also be one where, for example, a semiconductor element that generates a signal for driving the piezoelectric element 5 is mounted. The circuit board is fixed to the case 8 at a position where aligning adjustment has been performed on the outermost layer lens 1 and the inner layer lens 4 with the imaging element 7.

The outermost layer lens 1 is a light transmission body that transmits light having a predetermined wavelength (such as the wavelength of visible light or the wavelength at which an image can be taken by the imaging element), and is, for example, a convex meniscus lens. It should be noted that, in the optical device 10, a transparent member like a protective cover may be used instead of the outermost layer lens 1. The protective cover is made of glass or resin, such as transparent plastic.

An end portion of the outermost layer lens 1 is held by an end portion of a leaf spring 2a extending from the housing 2. It should be noted that a space between the outermost layer lens 1 and a retainer 2b provided at the end portion of the leaf spring 2a is filled with an adhesive. Further, for the purpose of vibrating the outermost layer lens 1 held by the housing 2, the optical device 10 includes the vibrator 3.

In the optical device 10 according to the embodiment, the outermost layer lens 1 and the vibrator 3 are not directly connected to each other, but instead, the outermost layer lens 1 and the vibrator 3 are connected to each other with the joining member 6 being interposed therebetween. FIG. 3 is a schematic view of the joining member 6 according to the first embodiment. As shown in FIG. 3, the joining member 6 has the shape of a ring. As shown in FIG. 1, the cross-sectional shape of the joining member 6 is a rectangular shape. The joining member 6 is such that the area of a surface A1 (a first surface) on a side that is adhered to part of the outermost layer lens 1 is equal to the area of a surface A2 (a second surface) on a side that contacts the vibrator 3.

When the outermost layer lens 1 is to be directly fixed to the vibrator 3 that is a cylindrical body by using an adhesive, pressure needs to be applied to the adhesive by applying a force to an end of the vibrator 3 on an opposite side situated far away from a side thereof that contacts the outermost layer lens 1, and thus it is difficult to make uniform the pressure that is applied to the adhesive. When variations occur in the thickness of an adhesive layer between the outermost layer lens 1 and the vibrator 3 and thus the adhesive layer cannot have uniform thickness, the vibration performance of the optical device 10 may deteriorate.

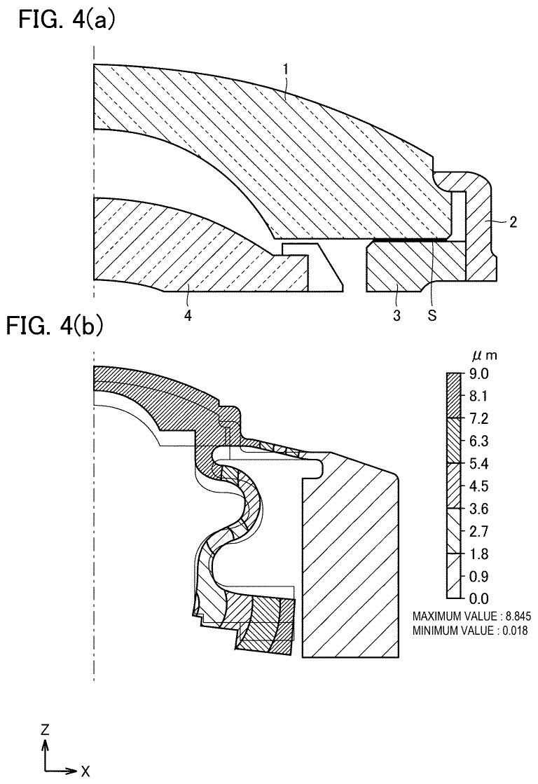

Specifically, vibration performances of the optical device are compared by performing vibration simulations on the optical device when the vibrator 3 is adhered in a parallel manner to the outermost layer lens 1 and when the vibrator 3 is adhered in a tilted manner to the outermost layer lens 1. FIGS. 4(a) and 4(b) are schematic views for illustrating the vibration performance of the optical device when the vibrator 3 is adhered in a parallel manner to the outermost layer lens 1. FIG. 4(a) is a schematic view showing that the vibrator 3 is adhered in a parallel manner to the outermost layer lens 1. It should be noted that the thickness of an adhesive layer S is 0.005 mm. FIG. 4(b) shows vibration simulation results of the optical device when the vibrator 3 is adhered in a parallel manner to the outermost layer lens 1.

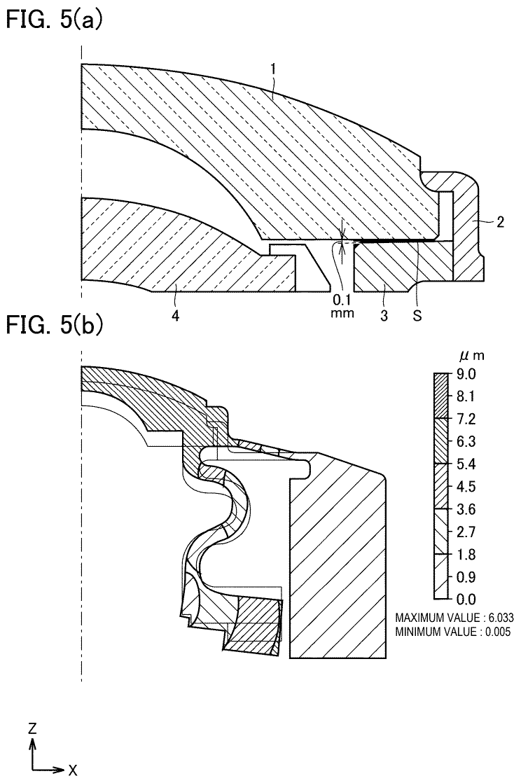

FIGS. 5(a) and 5(b) are schematic views for illustrating the vibration performance of the optical device when the vibrator 3 is adhered in a tilted manner to the outermost layer lens 1. FIG. 5(a) is a schematic view showing that an inner-layer-lens-4 side of the vibrator 3 is adhered with a tilt of 0.1 mm in a minus (−) Z axis direction with respect to the outermost layer lens 1. It should be noted that the thickness of an adhesive layer S is 0.005 mm. FIG. 5(b) shows vibration simulation results of the optical device when the inner-layer-lens-4 side of the vibrator 3 is adhered with the tilt of 0.1 mm in the minus (−) Z axis direction with respect to the outermost layer lens 1.

The vibration simulations in FIGS. 4(b) and 5(b) can be performed by using CAE (Computer Aided Engineering) software that can use a finite element method. The vibration simulations are results of calculation of displacement distribution of the optical device 10 when the vibrator 3 is vibrated in a vibration mode of resonant frequency (near 22.4 kHz). Comparison of the vibration simulation results in FIG. 4(b) and the vibration simulation results in FIG. 5(b) shows that, when the vibrator 3 is tilted with respect to the outermost layer lens 1, the displacement amount of the outermost layer lens 1 is decreased from approximately 8.8 μm to approximately 6.0 μm. This shows that variations in the thickness of the adhesive layer S of a portion that is joined to the outermost layer lens 1 considerably affect the vibration performance of the optical device.

For the purpose of making uniform the thickness of the adhesive layer of the portion that is joined to the outermost layer lens 1, a load produced when pressure is applied to the adhesive needs to be made uniform. However, the vibrator 3 is a cylindrical body as shown in FIG. 1, and includes a connection portion 31 (a first portion) that contacts the outermost layer lens 1, a vibration portion 32 (a second portion) where the piezoelectric element 5 is provided, and a support portion 33 (a third portion) that connects the connection portion 31 and the vibration portion 32 to each other; and the cross-sectional shape of the support portion 33 is an S shape. Therefore, pressure needs to be applied to the adhesive by applying a force to the end of the vibrator 3 on the opposite side situated far away from the side thereof that contacts the outermost layer lens 1, and thus it is difficult to make uniform the pressure that is applied to the adhesive.

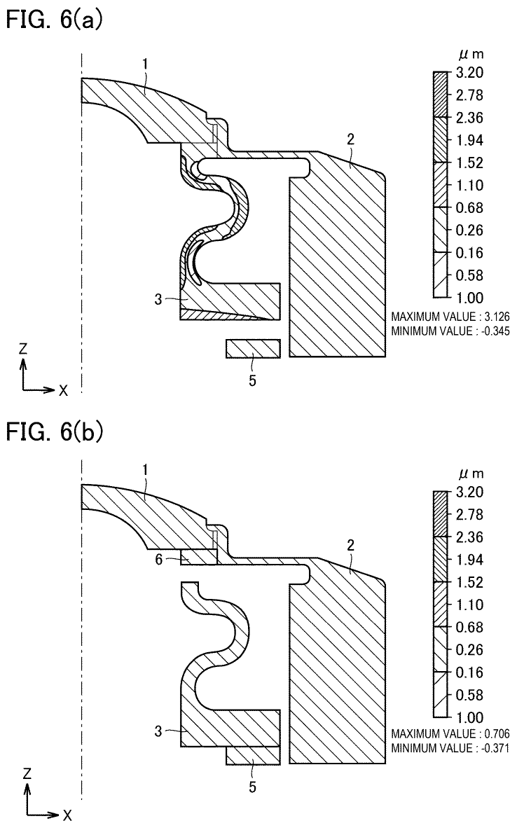

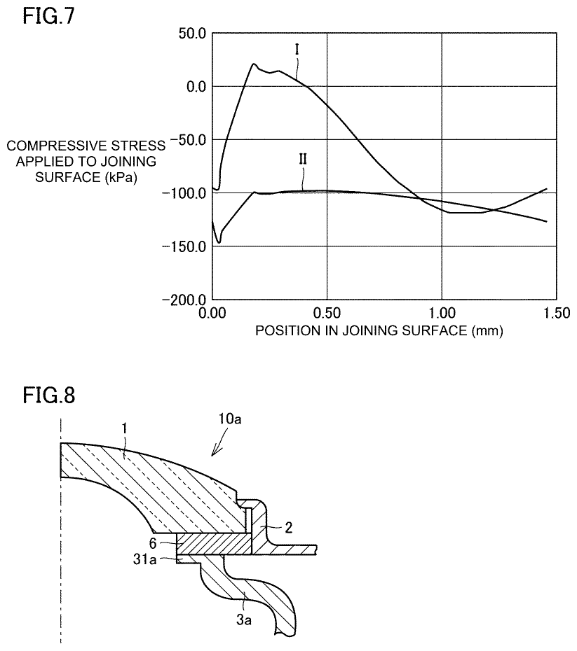

Specifically, stress distributions of the optical device are compared by performing stress simulations on the optical device when the vibrator 3 is directly connected to the outermost layer lens 1 and when the vibrator 3 is connected to the outermost layer lens 1 with the joining member 6 being interposed therebetween. FIGS. 6(a) and 6(b) are schematic views for illustrating stress that is applied to the vibrator 3 when adhering the outermost layer lens 1. FIG. 7 is a graph showing compressive stress that is applied to a joining surface (a joining surface where the outermost layer lens 1 and the vibrator 3 are joined to each other, or a joining surface where the outermost layer lens 1 and the joining member 6 are joined to each other). The horizontal axis shown in FIG. 7 indicates the position in the joining surface, and the vertical axis indicates the compressive stress related to the joining surface.

FIG. 6(a) shows stress stimulation results of the optical device 10 when the vibrator 3 is directly connected to the outermost layer lens 1. FIG. 6(b) shows stress simulation results of the optical device 10 when the vibrator 3 is connected to the outermost layer lens 1 with the joining member 6 being interposed therebetween. It should be noted that the simulations in FIGS. 6 and 7 were performed by using CAE software that can use a finite element method. It should be noted that the joining member 6 has a thickness of 0.8 mm and a width of 2.0 mm, and the adhesive layer has a thickness of 0.005 mm.

FIG. 6(a) shows the stress distribution produced in the vibrator 3 when a load of 20 N is applied to a surface of the vibrator 3 where the piezoelectric element 5 is provided. As shown in FIG. 6(a), since the cross-sectional shape of the vibrator 3 is an S shape, the load applied to the vibrator 3 is not uniformly applied to the joining surface where the outermost layer lens 1 and the vibrator 3 are joined to each other. On the other hand, FIG. 6(b) shows the stress distribution produced in the joining member 6 when a load of 20 N is applied to a surface of the joining member 6 on a side opposite to a side thereof that contacts the outermost layer lens 1. As shown in FIG. 6(b), since the cross-sectional shape of the joining member 6 is a rectangular shape, the load applied to the joining member 6 is uniformly applied to the joining surface where the outermost layer lens 1 and the joining member 6 are joined to each other.

More specifically, FIG. 7 shows, in a plane where the outermost layer lens 1 and the vibrator 3 or the joining member 6 are joined to each other, changes in the compressive stress in the joining surface with an end on a side of the inner layer lens 4 being at 0.00 mm. Graph I shows changes in the compressive stress in the joining surface for the case in FIG. 6(a), and shows that changes in the compressive stress are large in a range of 0.00 mm to 1.00 mm. On the other hand, Graph II shows changes in the compressive stress in the joining surface for the case in FIG. 6(b), and shows that the compressive stress in the joining surface is substantially constant.

Therefore, compared to when the vibrator 3 is directly connected to the outermost layer lens 1, when the vibrator 3 is connected to the outermost layer lens 1 with the joining member 6 being interposed therebetween, the thickness of the adhesive layer at the outermost layer lens 1 can be made more uniform and the vibration performance of the optical device 10 will not deteriorate.

Returning to FIG. 2, the vibrator 3 is a cylindrical body, and includes the connection portion 31, the vibration portion 32, and the support portion 33. The connection portion 31 shown in FIG. 2 has a circular cylindrical shape extended in an axial direction (Z direction) of the cylindrical body. However, for the purpose of ensuring a wide area of a portion that is joined to the joining member 6, the connection portion 31 may have a shape extended in a radial direction (X, Y direction) of the cylindrical body. FIG. 8 is a half-cross-sectional view of an optical device 10a according to Modification 1. In the optical device 10a, corresponding structures to those of the optical device 10 shown in FIG. 2 are given the same reference signs, and descriptions thereof are not repeated.

In a vibrator 3a shown in FIG. 8, for the purpose of ensuring a wide area of the portion that is joined to the joining member 6, a connection portion 31a includes a portion whose shape is extended in a radial direction of the cylindrical body. By providing the connection portion 31a, it is possible to stably connect the vibrator 3a to the joining member 6. It should be noted that, although, the connection portion 31a includes the portion whose shape is extended in a central axis direction of the optical device 10a, the connection portion 31a may include a portion whose shape is extended in an outer direction of the optical device 10a, or may include a portion whose shape is extended in the central axis direction and the outer direction of the optical device 10a.

Returning to FIG. 2, the vibration portion 32 of the vibrator 3 is a portion that, together with the piezoelectric element 5, vibrates, and its plate thickness is larger than the plate thicknesses of the connection portion 31 and the support portion 33. Therefore, the vibration of the piezoelectric element 5 is more easily efficiently transmitted to the outermost layer lens 1. The support portion 33 is a portion that supports the connection portion 31 and that transmits the vibration of the vibration portion 32 to the connection portion 31. It should be noted that the connection portion 31, the vibration portion 32, and the support portion 33 may be integrally or separately formed. A maximum external dimension of the support portion 33 (the third portion) is larger than a maximum external dimension of the connection portion 31 (the first portion), and a maximum external dimension of the vibration portion 32 (the second portion) is larger than the maximum external dimension of the support portion 33 (the third portion). Therefore, the vibration of the vibration portion 32 (that is, the vibration of the piezoelectric element 5) can be more efficiently transmitted to the outermost layer lens 1 (the light transmission body).

The piezoelectric element 5 is provided on a surface of the vibration portion 32 on a side opposite to a side thereof that contacts the outermost layer lens 1. The piezoelectric element 5 has a hollow circular shape, and, for example, vibrates due to polarization in a thickness direction. The piezoelectric element 5 is made of piezoelectric ceramic based on lead zirconate titanate. Nevertheless, other types of piezoelectric ceramic, such as (K, Na) NbO₃, may be used. Further, a piezoelectric single crystal, such as an LiTaO₃ single crystal, may be used.

When the hollow circular piezoelectric element 5 vibrates in a radial direction and the vibration is converted into vibration in the Z direction (up-down direction in the figure) by the support portion 33 of the vibrator 3, the outermost layer lens 1 vibrates in the Z direction. When the support portion 33 elastically deforms like a spring, the vibrator 3 displaces the outermost layer lens 1 in the Z direction. Due to the vibration of the vibrator 3, the leaf spring 2a of the housing 2 that holds the outermost layer lens 1 elastically deforms.

Although the vibrator 3 shown in FIG. 2 has been described as being connected to the joining member 6 by using an adhesive, the vibrator 3 may be connected to the joining member 6 by using a mechanical joining mechanism or may be connected to the joining member 6 by using an adhesive and a mechanical joining mechanism. An example in which the joining member 6 includes on a side thereof that contacts the vibrator 3 a mechanical joining mechanism for joining the joining member 6 to the vibrator 3 is described below. It should be noted that, instead of at the joining member 6, the mechanical joining mechanism may be provided at the vibrator 3 or at the joining member 6 and the vibrator 3.

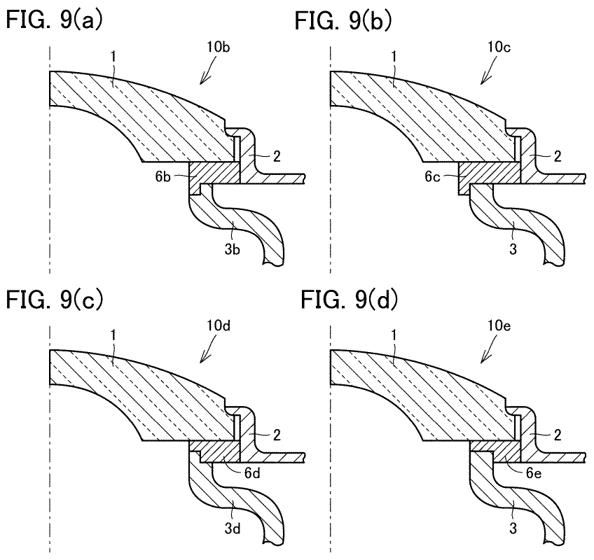

FIGS. 9(a) to 9(d) are schematic views for illustrating types of joinings between the joining member 6 and the vibrator 3. In an optical device 10b shown in FIG. 9(a), a surface on a side where a joining member 6b contacts a vibrator 3b has a convex portion, and an end on a side where the vibrator 3b contacts the joining member 6b has a concave portion. In the optical device 10b, corresponding structures to those of the optical device 10 shown in FIG. 2 are given the same reference signs, and descriptions thereof are not repeated.

In the optical device 10b, the joining member 6b and the vibrator 3b are connected to each other by fitting the convex portion of the joining member 6b and the concave portion of the vibrator 3b to each other. The convex portion of the joining member 6b and the concave portion of the vibrator 3b constitute a fitting mechanism, and constitute a mechanical joining mechanism of the optical device 10b. It should be noted that the convex portion of the joining member 6b and the concave portion of the vibrator 3b may each include a threaded portion to constitute a threaded mechanism. Alternatively, an adhesive may be applied to the convex portion of the joining member 6b and the concave portion of the vibrator 3b to fit them to each other.

In an optical device 10c shown in FIG. 9(b), a surface on a side where a joining member 6c contacts a vibrator 3 has a convex portion. In the optical device 10c, corresponding structures to those of the optical device 10 shown in FIG. 2 are given the same reference signs, and descriptions thereof are not repeated.

In the optical device 10c, the joining member 6c and the vibrator 3 are connected to each other by fitting an end portion of the vibrator 3 to the convex portion of the joining member 6c. The convex portion of the joining member 6c constitutes a fitting mechanism, and constitutes a mechanical joining mechanism of the optical device 10c. It should be noted that the convex portion of the joining member 6c and the end portion of the vibrator 3 may each include a threaded portion to constitute a threaded mechanism. Alternatively, an adhesive may be applied to the convex portion of the joining member 6c and the end portion of the vibrator 3 to fit them to each other.

In an optical device 10d shown in FIG. 9(c), a surface on a side where a joining member 6d contacts a vibrator 3d has a concave portion, and an end on a side where the vibrator 3d contacts the joining member 6d has a convex portion. In the optical device 10d, corresponding structures to those of the optical device 10 shown in FIG. 2 are given the same reference signs, and descriptions thereof are not repeated.

In the optical device 10d, the joining member 6d and the vibrator 3d are connected to each other by fitting the concave portion of the joining member 6d and the convex portion of the vibrator 3d to each other. The concave portion of the joining member 6d and the convex portion of the vibrator 3d constitute a fitting mechanism, and constitute a mechanical joining mechanism of the optical device 10d. It should be noted that the concave portion of the joining member 6d and the convex portion of the vibrator 3d may each include a threaded portion to constitute a threaded mechanism. Alternatively, an adhesive may be applied to the concave portion of the joining member 6d and the convex portion of the vibrator 3d to fit them to each other.

In an optical device 10e shown in FIG. 9(d), a surface on a side where a joining member 6e contacts a vibrator 3 has a concave portion. In the optical device 10e, corresponding structures to those of the optical device 10 shown in FIG. 2 are given the same reference signs, and descriptions thereof are not repeated.

In the optical device 10e, the joining member 6e and the vibrator 3 are connected to each other by fitting an end portion of the vibrator 3 to the concave portion of the joining member 6e. The concave portion of the joining member 6e constitutes a fitting mechanism, and constitutes a mechanical joining mechanism of the optical device 10e. It should be noted that the concave portion of the joining member 6e and the end portion of the vibrator 3 may each include a threaded portion to constitute a threaded mechanism. Alternatively, an adhesive may be applied to the concave portion of the joining member 6e and the end portion of the vibrator 3 to fit them to each other.

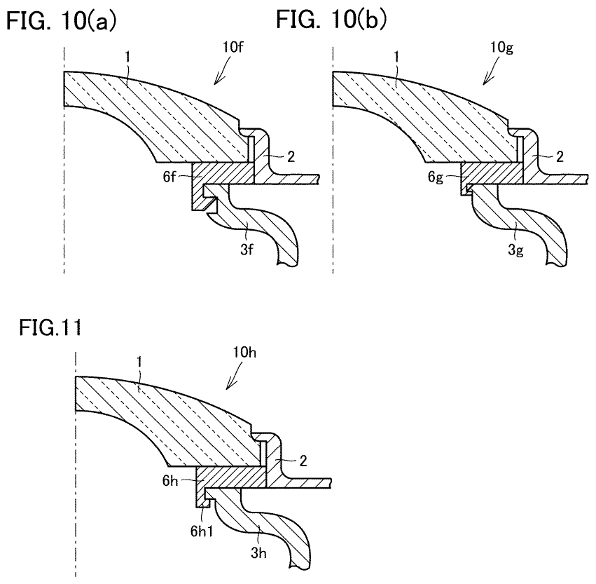

FIGS. 10(a) and 10(b) are schematic views for illustrating other types of joinings between the joining member and the vibrator. In an optical device 10f shown in FIG. 10(a), a surface on a side where a joining member 6f contacts a vibrator 3f has a claw portion, and an end on a side where the vibrator 3f contacts the joining member 6f has a concave portion. In the optical device 10f, corresponding structures to those of the optical device 10 shown in FIG. 2 are given the same reference signs, and descriptions thereof are not repeated.

In the optical device 10f, the joining member 6f and the vibrator 3f are connected to each other by engaging the claw portion of the joining member 6f and the concave portion of the vibrator 3f with each other. The claw portion of the joining member 6f and the concave portion of the vibrator 3f constitute a snap-fit mechanism, and constitute a mechanical joining mechanism of the optical device 10f. It should be noted that an adhesive may be applied to the claw portion of the joining member 6f and the concave portion of the vibrator 3f to engage them with each other.

In an optical device 10g shown in FIG. 10(b), a surface on a side where a joining member 6g contacts a vibrator 3g has a concave portion, and an end on a side where the vibrator 3g contacts the joining member 6g has a claw portion. In the optical device 10g, corresponding structures to those of the optical device 10 shown in FIG. 2 are given the same reference signs, and descriptions thereof are not repeated.

In the optical device 10g, the joining member 6g and the vibrator 3g are connected to each other by engaging the concave portion of the joining member 6g and the claw portion of the vibrator 3g with each other. The concave portion of the joining member 6g and the claw portion of the vibrator 3g constitute a snap-fit mechanism, and constitute a mechanical joining mechanism of the optical device 10g. It should be noted that an adhesive may be applied to the concave portion of the joining member 6g and the claw portion of the vibrator 3g to engage them with each other.

FIG. 11 is a schematic view for illustrating still another type of joining between the joining member and the vibrator. In an optical device 10h shown in FIG. 11, a surface on a side where a joining member 6h contacts a vibrator 3h includes a crimping portion 6h1. In the optical device 10h, corresponding structures to those of the optical device 10 shown in FIG. 2 are given the same reference signs, and descriptions thereof are not repeated.

In the optical device 10h, the joining member 6h and the vibrator 3h are connected to each other by bending the crimping portion 6h1 of the joining member 6h such that the crimping portion 6h1 engages with part of the vibrator 3h. The crimping portion 6h1 of the joining member 6h constitutes a crimping mechanism, and constitutes a mechanical joining mechanism of the optical device 10h. It should be noted that an adhesive may be applied to the crimping portion 6h1 of the joining member 6h and an end portion of the vibrator 3h to connect them to each other. Alternatively, an end on a side where the vibrator 3h contacts the joining member 6h may include a crimping portion.

Next, although the material of the joining member 6 may be the same as the material of the vibrator 3, the material may differ therefrom. When the material of the joining member 6 differs from the material of the vibrator 3, it is preferable that the coefficient of linear expansion of the joining member 6 be a value between the coefficient of linear expansion of the outermost layer lens 1 and the coefficient of linear expansion of the vibrator 3. This makes it possible to decrease by the joining member 6 thermal stress that is produced due to a difference between the coefficient of linear expansion of the outermost layer lens 1 and the coefficient of linear expansion of the vibrator 3, and to increase the reliability of the optical device 10.

Basically, the material of the joining member 6 may be any one of a metal (such as SUS (Steel Use Stainless), aluminum, brass, iron, kovar, or invar), ceramic (such as alumina or zirconia), and a resin (engineering plastic, such as PPS (Poly Phenylene Sulfide). When the joining member 6 is made of a metal, from the viewpoint of preventing oxidation, it is preferable that oxide coating treatment be performed. In a step of assembling the optical device 10, for the purpose of making it easier to detect foreign substances other than the joining member 6, the joining member 6 may be colored, for example, it is preferable that the joining member 6 be colored black.

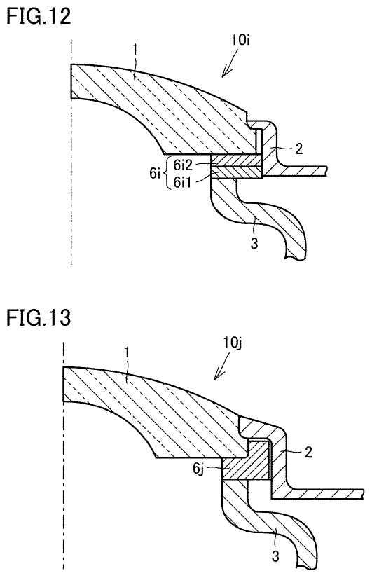

Next, a case in which the joining member 6 includes two layers instead of one layer as shown in FIG. 1 is described. FIG. 12 is a half-cross-sectional view of an optical device 10i according to Modification 2. In the optical device 10i, corresponding structures to those of the optical device 10 shown in FIG. 2 are given the same reference signs, and descriptions thereof are not repeated.

As shown in FIG. 12, the optical device 10i includes a joining member 6i including two layers in an axial direction of the vibrator 3. Although the joining member 6i may include two layers of the same material, the joining member 6i preferably includes two layers of different materials. In the joining member 6i, it is preferable that the material of a first layer 6i1 on a side that contacts the vibrator and the material of a second layer 612 on a side that is adhered to part of the outermost layer lens 1 differ from each other, and that the coefficient of linear expansion of the second layer 612 be nearer the coefficient of linear expansion of the outermost layer lens 1 than the coefficient of linear expansion of the first layer 6i1. This makes it possible to decrease by the joining member 6 thermal stress that is produced due to a difference between the coefficient of linear expansion of the outermost layer lens 1 and the coefficient of linear expansion of the vibrator 3, and to increase the reliability of the optical device 10. It should be noted that the joining member 6i may include three or more layers by using different materials.

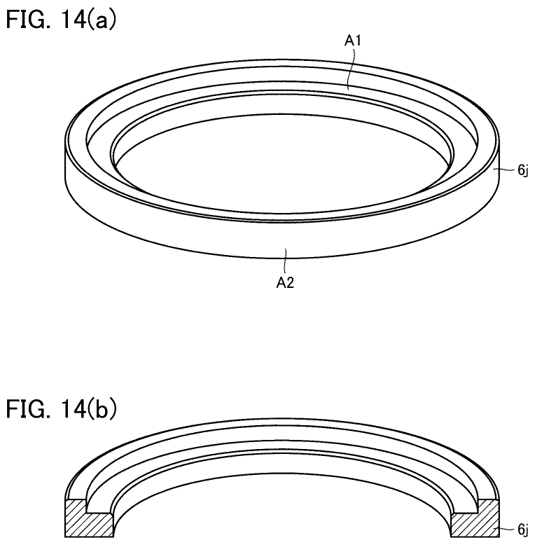

Although, in FIG. 1, the cross-sectional shape of the joining member 6 has been described as being a rectangular shape, it may be an L shape. FIG. 13 is a half-cross-sectional view of an optical device 10j according to Modification 3. FIGS. 14(a) and 14(b) are schematic views of a joining member 6j according to Modification 3. FIG. 14(a) is a perspective view of the joining member 6j, and FIG. 14(b) is a perspective view of the joining member 6j that has been cut in half. In the optical device 10j, corresponding structures to those of the optical device 10 shown in FIG. 2 are given the same reference signs, and descriptions thereof are not repeated.

As shown in FIG. 14(a), the joining member 6j has the shape of a ring. As shown in FIG. 14(b), the cross-sectional shape of the joining member 6j is an L shape. The joining member 6j is such that the area of a surface A1 (a first surface) on a side that is adhered to part of the outermost layer lens 1 is less than the area of a surface A2 (a second surface) on a side that contacts the vibrator 3. Therefore, the joining member 6j can limit the movement of the outermost layer lens 1 in a radial direction (X, Y direction) of a cylindrical body, and can make uniform the thickness of an adhesive layer between the joining member 6j and the outermost layer lens 1 by a force applied from a side of the surface A2.

Although the joining member 6 shown in FIG. 3 and the joining member 6j shown in FIGS. 14(a) and 14(b) have each been described as having the shape of a ring, they need not be integrally formed. The joining member 6 and the joining member 6j may each include a plurality of parts and the parts may be disposed in the shape of a ring between the outermost layer lens 1 and the vibrator 3.

### Second Embodiment

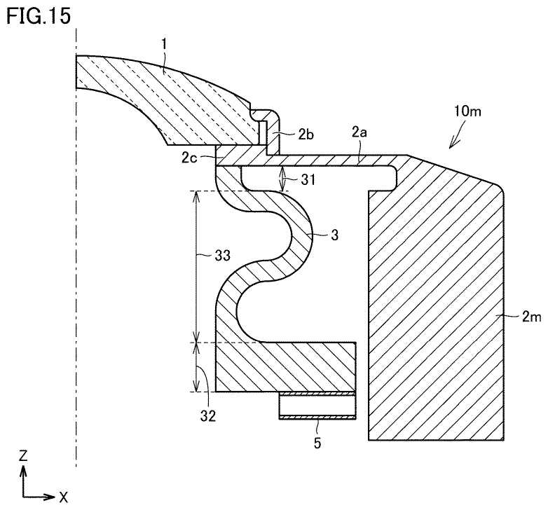

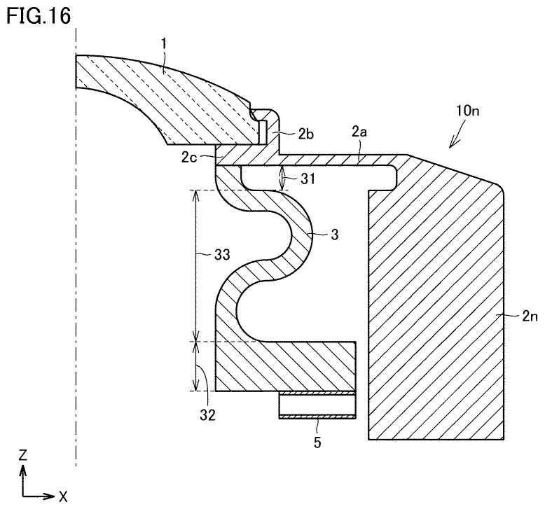

In the optical device 10 according to the first embodiment, as shown in FIG. 2, the housing 2 and the joining member 6 have been described as being formed as separate members. In the second embodiment, an optical device including a housing and a joining member that are integrated with each other is described. It should be noted that, when the housing and the joining member are integrated with each other as in the second embodiment, compared to the structure shown in FIG. 6(a) in which the vibrator 3 is directly connected to the outermost layer lens 1, the connection portion between the outermost layer lens and the vibrator is no longer required, as a result of which it is possible to decrease a water entry path from two locations to one location, which structure is advantageous from the viewpoint of water resistance. FIG. 15 is a half-cross-sectional view of an optical device 10m according to the second embodiment. In the optical device 10m, corresponding structures to those of the optical device 10 shown in FIG. 2 are given the same reference signs, and descriptions thereof are not repeated.

The optical device 10m includes an outermost layer lens 1, a housing 2m, a vibrator 3, an inner layer lens 4, and a piezoelectric element 5. The housing 2m includes a leaf spring 2a that extends toward the outermost layer lens 1, and a joining portion 2c that is provided at an end portion of the leaf spring 2a. A retainer 2b that is formed from a member separate from the housing 2m is provided at the end portion of the leaf spring 2a. When the joining portion 2c is disposed between the outermost layer lens 1 and the vibrator 3, and a space between the outermost layer lens 1 and the retainer 2b and the joining portion 2c is filled with an adhesive, the outermost layer lens 1 is held by the housing 2m. For the purpose of vibrating the outermost layer lens 1 held by the housing 2m, the vibrator 3 is connected to the joining portion 2c.

In the optical device 10m, since the vibrator 3 is connected to the outermost layer lens 1 with the joining portion 2c being interposed therebetween, compared to when the vibrator 3 is directly connected to the outermost layer lens 1, it is possible to make more uniform the thickness of an adhesive layer between the outermost layer lens 1 and the joining portion 2c and thus the vibration performance will not deteriorate. Since the joining portion 2c (joining member) is part of the housing 2m, it is possible to integrate the joining portion 2c with the housing 2m and to reduce manufacturing costs.

The housing may be integrated with not only the joining portion but also the retainer. FIG. 16 is a half-cross-sectional view of a different optical device 10n according to the second embodiment. In the optical device 10n, corresponding structures to those of the optical device 10 shown in FIG. 2 are given the same reference signs, and descriptions thereof are not repeated.

The optical device 10n includes an outermost layer lens 1, a housing 2n, a vibrator 3, an inner layer lens 4, and a piezoelectric element 5. The housing 2n includes a leaf spring 2a that extends toward the outermost layer lens 1, and a retainer 2b and a joining portion 2c that are provided at an end portion of the leaf spring 2a. That is, the retainer 2b and the joining portion 2c that are integrated with the housing 2n are provided at the end portion of the leaf spring 2a. When the joining portion 2c is disposed between the outermost layer lens 1 and the vibrator 3, and a space between the outermost layer lens 1 and the retainer 2b and the joining portion 2c is filled with an adhesive, the outermost layer lens 1 is held by the housing 2n. For the purpose of vibrating the outermost layer lens 1 held by the housing 2n, the vibrator 3 is connected to the joining portion 2c.

In the optical device 10n, since the vibrator 3 is connected to the outermost layer lens 1 with the joining portion 2c being interposed therebetween, compared to when the vibrator 3 is directly connected to the outermost layer lens 1, it is possible to make more uniform the thickness of an adhesive layer between the outermost layer lens 1 and the joining portion 2c and thus the vibration performance will not deteriorate. Since the retainer 2b and the joining portion 2c (joining member) are part of the housing 2n, it is possible to integrate the retainer 2b and the joining portion 2c with the housing 2n and to reduce manufacturing costs.

Although, in the optical devices 10m and 10n, the housing and the joining member have been described as being integrated with each other, it can also be understood that the outermost layer lens 1 and the vibrator 3 are connected to each other with part of the housing being interposed therebetween. That is, the optical devices 10m and 10n each include the outermost layer lens 1 that transmits light having a predetermined wavelength, the housing 2m or 2n that holds the outermost layer lens 1, the vibrator 3 that vibrates the outermost layer lens 1 through part of the housing 2m or 2n that holds the outermost layer lens 1, and the piezoelectric element 5 that is provided at the vibrator 3 and that vibrates the vibrator 3. The vibrator 3 can be considered as being a cylindrical body and including a first end portion (the connection portion 31) that contacts part of the housing 2m or 2n, and a second end portion (the vibration portion 32) where the piezoelectric element 5 is provided.

### Modifications

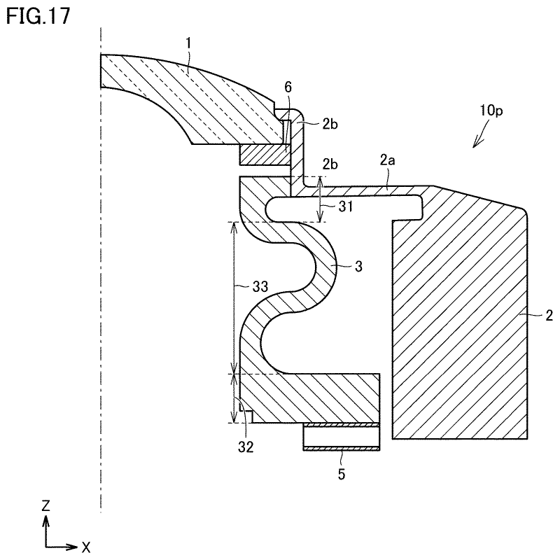

In the optical device 10 according to the embodiment above, as shown in FIG. 2, the joining member 6 and the vibrator 3 have been described as directly contacting each other. However, the joining member 6 and the vibrator 3 may indirectly contact each other with the housing 2 being interposed therebetween instead of the joining member 6 and the vibrator 3 directly contacting each other. FIG. 17 is a half-cross-sectional view of an optical device 10p according to Modification 4. In the optical device 10p, corresponding structures to those of the optical device 10 shown in FIG. 2 are given the same reference signs, and descriptions thereof are not repeated.

The optical device 10p includes an outermost layer lens 1, a housing 2, a vibrator 3, an inner layer lens 4, and a piezoelectric element 5. In the optical device 10p, the joining member 6 and the vibrator 3 are not directly connected to each other, but instead, the joining member 6 and the vibrator 3 are connected to each other with a retainer 2b of the housing 2 being interposed therebetween. That is, the joining member 6 and the vibrator 3 are each connected to the retainer 2b with a gap being formed between the joining member 6 and the vibrator 3, and a space exists between the joining member 6 and the vibrator 3.

First, in assembling the optical device 10p, the joining member 6 is adhered by using an adhesive to the outermost layer lens 1 held by the retainer 2b of the housing 2. It should be noted that an adhesive may also be applied to a surface where the joining member 6 and the retainer 2b contact each other. By inserting the joining member 6 into the housing 2 and holding the outermost layer lens 1 in this way, it is possible to make uniform a load distribution of an adhesion surface where the outermost layer lens 1 and the joining member 6 are adhered to each other and to further make uniform the thickness of an adhesive layer between the outermost layer lens 1 and the joining member 6.

Next, in assembling the optical device 10p, the vibrator 3 and the retainer 2b are connected to each other. Since the vibrator 3 is connected to the retainer 2b in a plane parallel to the Z direction allowing easy elastic deformation, when pressure is applied for connecting the vibrator 3 to the retainer 2b, the vibrator 3 itself need not be deformed. It should be noted that the vibrator 3 and the housing 2 may be connected to each other by connecting the vibrator 3 and a leaf spring 2a to each other instead of by connecting the vibrator 3 and the retainer 2b to each other. Therefore, in the optical device 10p, the joining member 6 and the vibrator 3 are to be indirectly connected to each other with part (for example, the retainer 2b or the leaf spring 2a) of the housing 2 being interposed therebetween.

In the optical device 10 according to the embodiment above, it has been described that although the joining member 6 and the vibrator 3 may be made of the same material, they may be made of different materials. However, in order to perform processing such that the thickness of an adhesive layer between the joining member 6 and the outermost layer lens 1 becomes uniform by applying pressure to the joining member 6 by pushing the joining member 6 against the outermost layer lens 1, it is preferable that the Young's modulus of the joining member 6 be less than the Young's modulus of the vibrator 3 (the joining member 6 be softer than the vibrator 3). Using for the joining member 6 a material having a Young's modulus that is less than that of the material of the vibrator 3 can decrease stress that is applied to a joining surface where the joining member 6 and the outermost layer lens 1 are joined to each other when, for example, pressure is applied or thermal stress is produced.

In the optical device 10 according to the embodiment above, although it has been described that the thickness of the joining member 6 is 0.8 mm, the thickness is not limited thereto. The thickness of the joining member 6 is determined by considering, for example, ease of adhesion to the outermost layer lens 1 and ease of transmission of the vibration of the vibrator 3 to the outermost layer lens 1.

In the optical device 10 according to the embodiment above, although it has been described that the cross-sectional shape of the support portion 33 is an S shape, the cross-sectional shape of the support portion is not limited to an S shape as long as it is a shape that does not allow stress to concentrate at the vibrator. The cross-sectional shape of the support portion 33 may be, for example, a shape formed by connecting a plurality of S shapes or a curved shape that is half of an S shape.

The imaging unit according to the embodiment above may include, for example, a camera, LiDAR, or Radar. A plurality of imaging units may be disposed side by side.

The imaging unit according to the embodiment above is not limited to an imaging unit that is provided in a vehicle, and may be any imaging unit that includes an optical device and an imaging element that is disposed such that a light transmission body defines a viewing direction, and that needs to remove foreign substances on the light transmission body.

Since the optical device according to the present disclosure includes a joining member that is adhered to part of the light transmission body, and the vibrator is provided with the joining member being interposed between the light transmission body and the vibrator, it is possible to provide an adhesive layer having a uniform thickness between the light transmission body and the joining member, and vibration performance is prevented from deteriorating.

Since the optical device according to the present disclosure includes part of the housing that is adhered to part of the light transmission body, and the vibrator is provided with the part of the housing being interposed between the light transmission body and the vibrator, it is possible to provide an adhesive layer having a uniform thickness between the light transmission body and the part of the housing, and vibration performance is prevented from deteriorating.

The embodiments disclosed here are exemplifications in terms of all points, and should be understood as not being restrictive. The scope of the present disclosure is indicated not by the descriptions above but by the claims, and is intended to include all changes within the scope of the claims and equivalent meanings.

### REFERENCE SIGNS LIST

1 outermost layer lens
2, 2m, 2n housing
2a leaf spring
2b retainer
2c joining portion
3, 3a, 3b, 3d, 3f, 3g, 3h vibrator
4 inner layer lens
5 piezoelectric element
6, 6b to 6d, 6f to 6j joining member
7 imaging element
8 case
10, 10a to 10d, 10f to 10j, 10m, 10n optical device
20 imaging device
31, 31a connection portion
32 vibration portion
33 support portion
100 imaging unit

1. An optical device comprising:
a light transmission body that transmits light having a predetermined wavelength;
a housing that holds the light transmission body;
a joining member adhered to part of the light transmission body;
a vibrator having a cylindrical body having a first end with a first portion that contacts the joining member, and a second end with a second portion, the vibrator constructed to vibrate the light transmission body through the joining member; and
a piezoelectric element connected the second portion at the second end of the vibrator and constructed to vibrate the vibrator.

2. The optical device according to claim 1, wherein the joining member has a shape of a ring.

3. The optical device according to claim 1, wherein a cross-sectional shape of the joining member is a rectangular shape or an L shape, and the joining member is configured such that an area of a first surface that is adhered to the part of the light transmission body is less than or equal to an area of a second surface that is parallel to the first surface and that contacts the first portion of the vibrator.

4. The optical device according to claim 1, wherein the joining member includes a mechanical joining mechanism for joining the joining member to the vibrator on a side thereof that contacts the first portion of the vibrator.

5. The optical device according to claim 4, wherein the joining mechanism includes any one of a fitting mechanism, a threaded mechanism, a snap-fit mechanism, and a crimping mechanism.

6. The optical device according to claim 1, wherein the joining member is made of a material differing from a material of the vibrator.

7. The optical device according to claim 6, wherein a coefficient of linear expansion of the material of the joining member is a value between a coefficient of linear expansion of a material of the light transmission body and a coefficient of linear expansion of the material of the vibrator.

8. The optical device according to claim 1, wherein the joining member includes two or more layers in an axial direction of the vibrator.

9. The optical device according to claim 8, wherein, among the two or more layers, a material of a first layer on a side of the joining member that contacts the vibrator and a material of a second layer on a side of the joining member that is adhered to the part of the light transmission body differ from each other, and a coefficient of linear expansion of the second layer is nearer a coefficient of linear expansion of the light transmission body than a coefficient of linear expansion of the first layer.

10. The optical device according to claim 9, wherein a coefficient of linear expansion of the second layer is nearer a coefficient of linear expansion of the light transmission body than a coefficient of linear expansion of the first layer.

11. The optical device according to claim 1, wherein a cross-sectional shape of a third portion of the vibrator that connects the first portion and the second portion to each other is a curved shape.

12. The optical device according to claim 11, wherein the cross-sectional shape of the third portion is an S shape.

13. The optical device according to claim 1, wherein the first portion of the vibrator includes a portion that extends in a radial direction of the cylindrical body.

14. The optical device according to claim 1, wherein the joining member is part of the housing.

15. The optical device according to claim 1, wherein the joining member and the vibrator are indirectly connected to each other with part of the housing being interposed therebetween.

16. An imaging unit comprising:
the optical device according to claim 1; and
an imaging element that is disposed such that the light transmission body defines a viewing direction.

17. An optical device comprising:
a light transmission body that transmits light having a predetermined wavelength;
a housing that holds the light transmission body;
a vibrator having a cylindrical body having a first end portion that contacts a part of the housing that holds the light transmission body, and a second end portion; and
a piezoelectric element at the second end portion of the vibrator.

18. The optical device according to claim 17, wherein the housing includes a leaf spring that extends toward the light transmission body, a joining portion at an end portion of the leaf spring, and a retainer at the end portion of the leaf spring.

19. The optical device according to claim 18, wherein the retainer is a member separate from the housing.

20. An imaging unit comprising:
the optical device according to claim 17; and
an imaging element that is disposed such that the light transmission body defines a viewing direction.
